(19) United States
(12) Patent Application Publication
(10) Pub. No.: US 2015/0348402 A1
(43) Pub. Date: Dec. 3, 2015

(54) REMOTE CONTROL HAVING OPERATION PROMPTING THEREFOR AND OPERATION METHOD THEREOF

(71) Applicant: Cybiowin Electronic (ShenZhen) Company Limited, Shenzhen City (CN)

(72) Inventors: BOON CHEN LIM, Shenzhen City (CN); YEUNG HOW LIM, Shenzhen City (CN)

(21) Appl. No.: 14/720,735

(22) Filed: May 22, 2015

Related U.S. Application Data
(63) Continuation-in-part of application No. PCT/CN2015/070481, filed on Jan. 9, 2015.

(30) Foreign Application Priority Data
May 28, 2014 (CN) PCT/CN2014/078618

(51) Int. Cl. G08C 17/02

(52) U.S. Cl. CPC G08C 17/02; G08C 2201/31; G08C 2201/20

(57) ABSTRACT

A remote control for electric appliance comprises a digital signal processor (DSP), a memory, a speech synthesizer and a keyboard comprising keys therein. The memory is signal communicable with the DSP for storing a database, and a series of favorite television station names and related television channel numbers are stored in the database. The speech synthesizer is controlled by the DSP to generate voice prompts for users to follow and operate the remote control step by step. The keyboard is signal communicable with the DSP, and comprises at least one set of keys to trigger voice prompts from the speech synthesizer for user operation on the remote control. A method to operate the remote control comprises a step of establishing a database in the remote control, a step of pressing a key from a keyboard and a step of prompting users to operate the remote control step by step.

### CROSS REFERENCE

The application is a U.S. continuation-in-part application under 35 U.S.C. §111(a) claiming priority under 35 U.S.C. §120 and §365(c) to International Application No. PCT/CN2015/070481 filed Jan. 9, 2015, which claims the priority benefit of International Application No. PCT/CN2014/078618 filed May 28, 2014, the contents of which are incorporated by reference herein in their entirety for all intended purposes.

### FIELD OF THE INVENTION

The present invention relates to a remote control and an operation method thereof, and particularly, to a remote control equipped with built-in prompting generators for generating a series of prompting instructions for users to operate the remote control step by step.

### DESCRIPTION OF RELATED ART

Using remote controls to control various home electric appliances can be complex or tedious setting and processing procedures for most people. In existing technology for remote controls, a conventional way for setting up a universal remote control in order to control a particular electric appliance includes at least a first step to aim the universal remote control at the particular electric appliance, and a second step to continuously press keys on the universal remote control for transmittal proper command codes in sequence. Once one of the command codes is successfully tested and verified on the particular electric appliance, a next one of the command codes will be tested and verified in order. However, such setting/processing procedures are apparently complex and difficult to follow, and using and operation thereof is complicated as well and time consuming.

### SUMMARY OF THE INVENTION

In order to overcome the above mentioned shortcoming, a first objective of the present invention is simplifying setting-up procedures of remote controls for easy processing. A second objective of the present invention is simplifying operations of remote controls for easy use of users.

A remote control for electric appliance in accordance with the present invention comprises a digital signal processor (DSP), a memory, a speech synthesizer and a keyboard comprising keys therein. The memory is signal communicable with the DSP for storing a preset database, and a series of favorite television station names and related television channel numbers are stored in the database. The speech synthesizer is signal communicable with the DSP and controlled by the DSP to generate voice prompts for users to follow and operate the remote control step by step. The keyboard is signal communicable with the DSP, and comprises at least one set of keys to trigger voice prompts from the speech synthesizer for user operation on the remote control. The user operation on the remote control comprises one of an operation to look up favorite television station channels from the database, an operation to modify information in a list of favorite television station channels in the database and an operation to add a favorite television station channel in the list of favorite television station channels in the database.

Preferably, one of an infrared transmitter/receiver and a radio frequency (RF) transmitter/receiver is adopted for signal communication of the remote control with other communicable appliance.

Preferably, the RF transmitter/receiver is used to locate the remote control when a RF signal is transmitted from the users trying to locate the remote control.

Preferably, the RF transmitter/receiver is used for intercom communication when the remote control is used as an intercom to communicate with another remote control or other intercom devices.

Preferably, the memory is removable from the remote control and replaceable by another memory comprising another database, different from the database, stored therein.

Preferably, a microphone is used to record voices of the users when a favorite television station name is required to be input into the remote control.

Preferably, a favorite television station channel which is newly accessed or added into the database is listed at a first place of the list of the favorite television station channels, and other favorite television station channels listed in the list are moved backwards in sequence.

Preferably, a favorite television station channel newly selected for watching during the operation to look up favorite television station channels from the database is listed at a first place of the list of the favorite television station channels, and other favorite television station channels listed in the list are moved backwards in sequence.

Preferably, the keyboard comprises keys to trigger voice prompts of key names for users to choose keys for operations of the remote control in a visual impaired operation mode of the remote control.

Preferably, sensors are used to receive feedback signals from the electric appliance when the remote control is operated to test the electric appliance.

A method to operate the remote control of electric appliance in accordance with the present invention comprises a step of establishing a database in the remote control, a step of pressing a key from a keyboard of the remote control and a step of prompting users of the remote control to operate the remote control step by step based on the pressed key. User operation on the remote control comprises one of an operation to look up favorite television station channels from the database, an operation to modify information in a list of favorite television station channels in the database and an operation to add a favorite television station channel in the list of favorite television station channels in the database.

Preferably, the method further comprises a step of placing a favorite television station channel newly added in the list at a first place of the list when the user operation is the operation to add a favorite television station channel in the list of favorite television station channels in the database.

Preferably, the method further comprises a step of placing a favorite television station channel newly selected for watching at a first place of the list when the user operation is the operation to look up favorite television station channels from the database.

Preferably, the method further comprise a step of prompting key names one by one for users to choose a key from the keyboard for execution before the step of pressing a key from a keyboard of the remote control.

Preferably, voice prompting is used in the step of prompting key names one by one for users to choose a key.

Preferably, voice prompting is used in the step of prompting users of the remote control to operate the remote control.

Preferably, the method further comprises a step of recording user's speaking voices as a part of additive information in the database.

Preferably, the method further comprises a step of playing back the recorded voices for review after the step of recording user's speaking voices.

Preferably, the additive information in the database comprises a recorded television station name and a television channel number keyed in from the keyboard of the remote control, and both of the recorded television station name and the keyed-in television channel number are played back for review.

Preferably, a voice prompt of a television station name is played for review after the key is pressed and a television channel number is transmitted in response to pressing of the key.

The physical embodiments adopted in the present invention will be presented by the following depicted embodiments and accompanying drawings for further explanations.

### BRIEF DESCRIPTION OF THE DRAWINGS

FIG. 1 is an illustrative diagram of components in a remote control in accordance with an embodiment of the present invention;

FIG. 2 is a plan view of a control panel of the remote control in accordance with the embodiment of the present invention.

FIG. 3 is a plan view of a control panel of a remote control in accordance with another embodiment of the present invention.

### DETAILED DESCRIPTION OF THE INVENTION

In order to facilitate understanding of the present invention, the following descriptions accompanying attached drawings are presented to further completely describe the present invention. Attached drawings show a preferred embodiment of the present invention. However, the present invention may be implemented by many different forms thereof and is not limited to the preferred embodiments described herein. On the contrary, the purpose of providing these embodiments is for much more thorough and entire understanding of the published disclosure of the present invention.

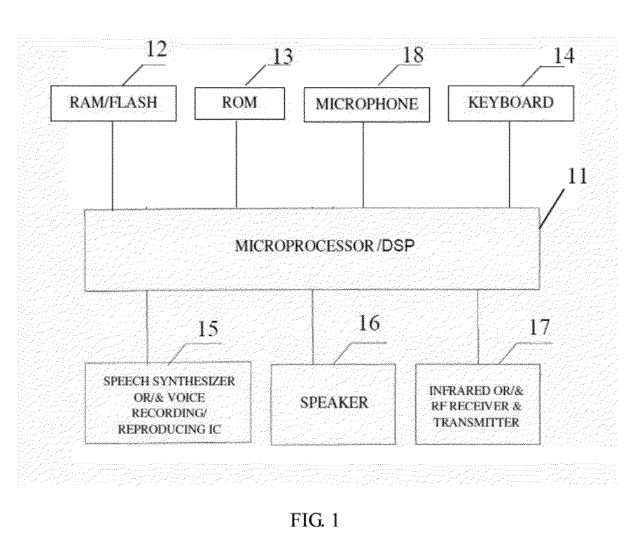

Referring to FIG. 1, a remote control of a preferred embodiment of the present invention comprises a digital signal processor (DSP) or microprocessor 11, a random access memory (RAM) 12 or a flash memory, a read-only memory (ROM) 13, a keyboard 14, a speech synthesizer 15 or a combined module comprising a speech synthesizer and a voice recording/reproducing integrated circuit (IC), a speaker 16 or a buzzer, an infrared transmitter/receiver 17 or a radio frequency (RF) transmitter/receiver, and a microphone 18. The DSP/microprocessor 11 is electrically connected to each of the above mentioned other components for controlling purposes. In a preferring embodiment of the present invention, the speech synthesizer 15 can also be omitted by functionally software programmed by the DSP/microprocessor 11 and the RAM/Flash memory 12, or be functionally integrated in the DSP/microprocessor 11 and the RAM/Flash memory 12.

In a preferred embodiment of the present invention, a database or a library is preset in the remote control to store a set of television station names with or without corresponding television channel numbers. The database is established and stored in the ROM 13 or the RAM/flash memory 12 during manufacturing of the remote control. The database is controlled and accessible by the DSP/microprocessor 11 for further use. Additional television station names or channel numbers thereof can be directly input by users via voice recording, keying in or other inputting method(s) and stored in the database or the RAM 12 afterwards.

In a preferred embodiment, the database or library is stored in a removable card-like module, such as a flash memory or a Secure Digital (SD) card. The removable module is replaceable based on user's need, such as a need to acquire a new database of television station names or channel numbers in a different country or area.

In a preferred embodiment, the preset database or library is a preset database comprising a list of favorite or popular television station channels of users stored therein. Users are instructed to follow a set of voice prompts to look up favorite television station channels and related channel numbers from the database one by one by pressing a favorite television station channel scanning key of the remote control. A “Send” key is required to be pressed when a favorite television station channel is found from the database, and users can therefore turn their television(s) to the found favorite television station channel for watching.

In a preferred embodiment, a newly accessed or added television station channel is automatically assigned as the first television station channel in the favorite television station channel list. The other television station channels which are originally listed are moved backwards in sequence. In another preferred embodiment, a favorite television station channel is searched out from the favorite television station channel list by successively pressing a favorite television station channel search key based on a preset setting. A proper television channel number is associated with the searched television station channel, or a correct television channel number is modified for the searched television station channel if an error is found. Any change made to the searched television station channel is stored after an input key, such as a “SEND” key, is pressed.

In a preferred embodiment of the present invention, the remote control is further equipped with functions for semiautomatic expanding/adding of Favorite TV station database/Library. Ordinarily, a user of a television (TV) is used to press a “Channel Up/+” key and a “Channel Down/−” key, or to directly press digital key(s) for acquiring combination of a particular television channel number in order to select a TV station channel/television program the user desires for watching. In the preferred embodiment of the present invention, when a “Channel Up/+” key, a “Channel Down/−” key, or any digital key(s) of the remote control is pressed and a corresponding television channel number is transmitted to television(s), the transmitted television channel number is compared with the list of favorite television station channels stored in the database/library of the remote control. If a same television channel number is found in the list of favorite television station channels of the database/library, a voice prompt of a corresponding television station name is then played and provided for the user to listen. In the case that no corresponding television station name to the transmitted television channel number is found from the list of favorite television station channels in the database/library, the user simply needs to press the “FAV ↓” key 101 and a voice prompt of “Speak the television station name for the television channel number your just keyed in after the ‘Tone’ sound” will be played and provided for the user. After a prompt “Tone” sound from the remote control is heard, the user can speak the correct television station name to the remote control for recording, and the recorded television station name together the keyed-in television channel number will be played back for the user to review. If the recorded television name and the keyed-in television channel number are considered to be correct for the particular television station channel by the user, the remote control automatically adds the particular television station channel at a top of the list of favorite television station channels in the database/library for future use of the user.

The DSP/microprocessor 11 further controls the speech synthesizer 15 or the voice recording/reproducing integrated circuit (IC) to generate voice instruction(s). The voice instruction(s) is used to prompt users of the remote control for operating or setting up the remote control step by step. Particularly, a list of favorite television station channel(s) is set up step by step by users following prompt(s) of the generated voice instruction(s) by the DSP/microprocessor 11 based on television station names and television channel numbers retrieved from the database. Searching television station channels and their station names, and transmitting, modifying or adding television channel numbers can also be achieved by a similar procedure as depicted above.

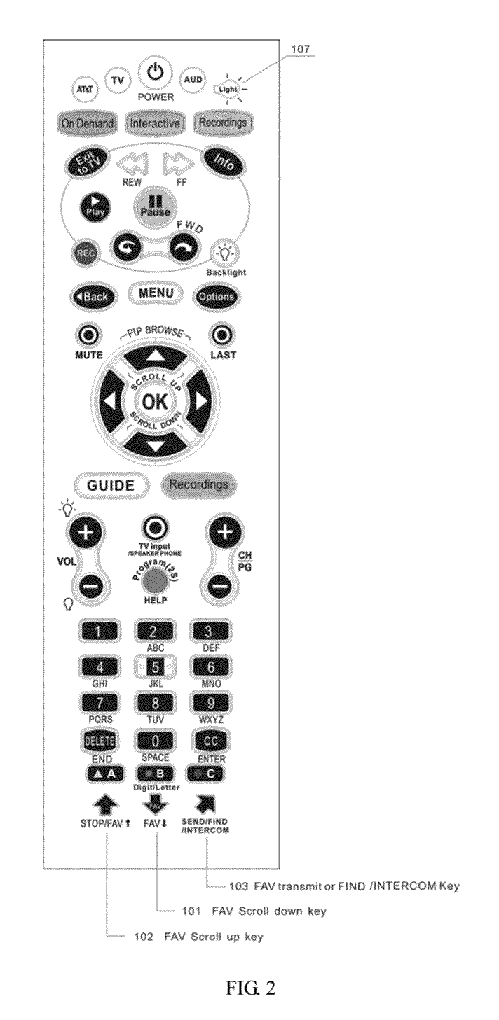

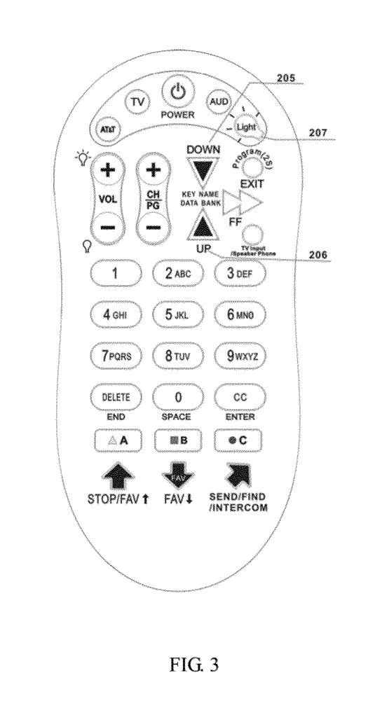

Referring to FIG. 2, more detailed in a preferred embodiment of the present invention, a set of “FAV” keys is preset on a control panel of the remote control. The set of “FAV” keys comprises at least a favorite channel scroll down key “FAV ↓” 101, a favorite channel scroll up key “FAV ↑” 102, and a favorite channel transmitting key “SEND/FIND/INTERCOM” 103. In another embodiment as shown in FIG. 3, the set of “FAV” keys further comprises a key name scroll down key “DOWN” 205 and key name scroll up key “UP” 206.

In a first preferred embodiment of the present invention, the remote control is operated based on the following. A series of favorite or popular television station names and related channel numbers is preset in the database of the remote control during manufacturing. A voice prompt, such as “Continuously and repeatedly pressing the ‘FAV ↓’ key 101, you will hear a series of television station names. If a favorite television station name of yours is heard, and its related television channel number is correct, please press the ‘SEND/FIND/INTERCOM’ key 103. If the related television channel number is incorrect, or no related television channel number is provided together with the favorite television station name, please key in a correct television channel number before pressing the ‘SEND/FIND/INTERCOM’ key 103. The television will be automatically turned to the favorite television station channel for watching.”, can be heard from the remote control when either the “FAV ↓” key 101 or the “FAV ↑” key 102 is pressed by users. All of transmitted television station channels during the above mentioned process will be automatically moved to a first place of the preset list of the favorite television station channels while other television station channels on the list will be therefore move backwards in sequence. The microphone 18 disposed at a side of the remote control is used to record user's voices for input of the required television station names and/or channel numbers. The keyboard 14 of the remote control is also useable for inputting the required television station names.

Either the “FAV ↓” key 101 or the “FAV ↑” key 102 can be pressed continuously in advance for checking the list of the favorite television station names and channel numbers entirely and finding out if all of the favorite television station channels on the list respectively have related television channel numbers provided therewith, or finding out if any of the related television channel numbers is incorrect in an area/region where users are located. In the case that no related television channel number is provided or the provided television channel number is incorrect, a correct television channel number can be input via the keyboard 14 of the remote control before an input confirmation “ENTER” key (not labeled) is pressed to complete the input of the correct television channel number. Of course, users can press the “SEND/FIND/INTERCOM” key 103 afterwards to verify correctness of a previous input if the users so desire.

Users can also edit or modify the list of the favorite television station channels in the database, or add a new favorite television station channel to the database. In the first preferred embodiment, any input favorite television station name is input via voice recording from the microphone 18 while any input favorite television channel number is input via keying in of the keyboard 14 of the remote control. In particular, after pressing and holding the “FAV ↓” key 101 for 3 seconds to enter a voice recording mode of the remote control, a voice prompt such as “Please speak the television station name to the microphone and then key in the television channel number from the keyboard.” can be heard as instruction(s) for users to follow and operate the remote control. After keying in the required television channel number, the “ENTER” key is pressed to complete entry and save the new favorite television station channel to the database. Furthermore, users can review voice recording of their own by playing back the recorded voices of the users, or can take further actions, such as voice game playing, based on the voice recording.

In a preferred embodiment of the present invention, a device locating function can be performed by the speech synthesizer 15 and the RF transmitter/receiver 17 together. In particular, the RF transmitter/receiver 17 is used to respond to a paging/search signal transmitted from users and to transmit a control signal to the speech synthesizer 15 for response. The speech synthesizer 15 is used to generate voice prompt(s) to instruct users to locate/find the remote control. If users cannot immediately find a location of the remote control, or the remote control is located somewhere hard to find, such as being under a desk or covered by a pile of paper, users can use an independent RF transmitter to transmit the paging/search signal to the RF transmitter/receiver 17 of the remote control, and the speech synthesizer 15 is controlled by the RF transmitter/receiver 17 of the remote control to respond to a voice prompt for the users, such as “Here I am”, to find the missing remote control. In the case that two of the same remote controls of the present invention are available together, the “SEND/FIND/INTERCOM” key 103 as shown in FIG. 2 or a “SEND” key shown in FIG. 3 can be used to trigger the above mentioned locating function when one of the two same remote controls is missing and the other of the two same remote control is in a non-favorite-television-channel-accessing mode (or in an “idle” mode).

In a preferred embodiment of the present invention, the remote control can be used as an intercom by utilizing at least the existing microphone 18 and speaker 16 of the remote control without adding additional electronic components in the remote control. A pair of the same remote controls of the present invention is required to function as communicable intercoms to each other. In the first preferred embodiment, the “SEND/FIND/INTERCOM” key 103 as shown in FIG. 2 of a first one of the pair of the remote controls is pressed and held for 2 seconds to start intercom communication by transmitting an RF signal to call/awaken a second one of the pair of the remote controls. The second one of the pair of the remote controls generates a tone, sound or voice prompt to inform users of the second one of the pair of the remote controls to answer the incoming call from the first one of the pair of the remote controls when the RF signal is received. After a preset key, such as the “INTERCOM” key 103, of the second one of the pair of the remote controls is pressed to stop the generated tone, sound or voice prompt, conversation(s) between users of the pair of the remote controls can be started. Alternatively, the generated tone, sound or voice prompt only lasts for a preset short duration of time. Users of the pair of the remote controls can start to talk to each other right after the RF signal is transmitted in response to triggering of the intercom communication, or after the preset duration of time lapses to avoid mixture of user conversation and the generated tone, sound or voice prompt. If a number of parties who want to join the intercom conversation of the remote controls are more than two, each of remote controls for the number of parties can be registered with a station number for identification.

Furthermore, the remote control of a preferred embodiment of the present invention can also be used as a speakerphone. In order to function as a speakerphone, the remote control of the present invention can be additionally equipped with a simple sound volume amplifying IC or two to three amplifying transistors to increase a volume of the speaker 16. The digital signal processor (DSP) 11 is used in the remote control of the present invention to perform as a full duplex or a semi-duplex speakerphone for better speaking quality without adding additional electronic components. The semi-duplex speakerphone performed by the remote control of the present invention can also be used for the above mentioned intercom function. A telephone modular jack can be added in the remote control of the present invention for connection to telephone lines in order to acquire enough electric power from the telephone lines instead of batteries. A lighting or high voltage current surge protector can also be added in the remote control of the present invention when the remote control is connected to telephone lines.

The remote control of a preferred embodiment of the present invention can be further built-in and equipped with a visual impaired operation mode. When the visual impaired operation mode is started, pressing any key from the keyboard 14 of the remote control at a first time is only used to trigger a voice prompt including a key name of the pressed key. Signal(s) or control command(s) defined by the pressed key will be transmitted or executed when visual impaired users correctly understand defined meanings of the pressed key and the pressed key is repeatedly pressed by the visual impaired users for a second time. The visual impaired operation mode can also be switched on when users are about to use the remote control in a dark place or light controlled environment.

In a preferred embodiment of the present invention, each key of the keyboard 14 is shaped so that a functional meaning represented by the each key can be easily recognized by users via finger touch thereof. Examples of specialized key shapes can be referred to an arrow shape of the keys 101, 102, 103 and a bulb shape of the key 107 in FIG. 2, or the key 207 in FIG. 3.

In a preferred embodiment of the present invention, the remote control of the present invention is able to provide voice prompt(s) for other operation thereof, including operation of remote controlling home electric appliance, etc. When the remote control is set to a home electric alliance remote controlling mode thereof, the remote control will provide voice prompt(s) to instruct users to set up related command codes for automatically executing remote controlling processes, including instruction(s) to users to press proper keys for automatically transmitting command(s) to the remote controlled home electric appliance.

In a preferred embodiment of the present invention, the remote control of the present invention further comprises a built-in feedback sensor(s), such as a microphone with a sound recognizer or a light sensor. The remote control is able to provide test result(s) of the home electric appliance based on sensed feedback signals from the home electric appliance to be tested.

In a preferred embodiment of the present invention, the key name stroll down key “DOWN” 205 and the key name stroll up key “UP” 206 as shown in FIG. 2 are used to trigger voice prompts of key names based on a preset sequence of the key names in the remote control. Particularly, pressing either the “DOWN” key 205 or the “UP” key 206 at one time triggers a voice prompt of a first key name, and pressing the same key at a second time triggers another voice prompt of a second key name next to the first key name according to the preset sequence of the key names. When a desired key name is prompted, users of the remote control can press the “ENTER” key to transmit related key command(s).

Descriptions and applications of the present invention herein are intended to be illustrative, not intended to limit the scope of the present invention to the above described embodiment. Variations and modifications of the embodiment disclosed herein are possible, and for those of ordinary skilled in the field, alternatives and equivalents of various components of the embodiment disclosed herein are common senses and well known. Where any person skilled in this art should know that the present invention can be achieved in other forms, structures, arrangements, proportions, and with other components, materials, and parts, the changes or improvements are still covered within the inventive spirit of the present invention and the scope as defined in the following claims. Without departing from the spirit and scope of the present invention, other modifications and changes of the embodiment disclosed herein can be made and still be covered by the claimed scope of the following claims.

1. A remote control for electric appliance, comprising:
a digital signal processor (DSP);
a memory being signal communicable with the DSP for storing a preset database, a series of favorite television station names and related television channel numbers stored in the database;
a speech synthesizer being signal communicable with the DSP, and being controlled by the DSP to generate voice prompts for users to follow and operate the remote control step by step; and
a keyboard comprising keys being signal communicable with the DSP, the keyboard comprising at least one set of keys to trigger voice prompts from the speech synthesizer for user operation on the remote control comprising one of an operation to look up favorite television station channels from the database, an operation to modify information in a list of favorite television station channels in the database and an operation to add a favorite television station channel in the list of favorite television station channels in the database.

2. The remote control as claimed in claim 1, further comprising one of an infrared transmitter/receiver and a radio frequency (RF) transmitter/receiver for signal communication of the remote control with other communicable appliance.

3. The remote control as claimed in claim 2, wherein the RF transmitter/receiver is used to locate the remote control when a RF signal is transmitted from the users trying to locate the remote control.

4. The remote control as claimed in claim 2, wherein the RF transmitter/receiver is used for intercom communication when the remote control is used as an intercom to communicate with another remote control or other intercom devices.

5. The remote control as claimed in claim 1, wherein the memory is removable from the remote control and replaceable by another memory comprising another database, different from the database, stored therein.

6. The remote control as claimed in claim 1, further comprising a microphone to record voices of the users when a favorite television station name is required to be input into the remote control.

7. The remote control as claimed in claim 1, wherein a favorite television station channel which is newly accessed or added into the database is listed at a first place of the list of the favorite television station channels, and other favorite television station channels listed in the list are moved backwards in sequence.

8. The remote control as claimed in claim 1, wherein a favorite television station channel newly selected for watching during the operation to look up favorite television station channels from the database is listed at a first place of the list of the favorite television station channels, and other favorite television station channels listed in the list are moved backwards in sequence.

9. The remote control as claimed in claim 1, wherein the keyboard comprises keys to trigger voice prompts of key names for users to choose keys for operations of the remote control in a visual impaired operation mode of the remote control.

10. The remote control as claimed in claim 1, further comprising sensors to receive feedback signals from the electric appliance when the remote control is operated to test the electric appliance.

11. A method to operate a remote control of electric appliance, comprising:
establishing a database in the remote control;
pressing a key from a keyboard of the remote control; and
prompting users of the remote control to operate the remote control step by step based on the pressed key;
wherein user operation on the remote control comprises one of an operation to look up favorite television station channels from the database, an operation to modify information in a list of favorite television station channels in the database and an operation to add a favorite television station channel in the list of favorite television station channels in the database.

12. The method as claimed in claim 11, further comprising a step of placing a favorite television station channel newly added in the list at a first place of the list when the user operation is the operation to add a favorite television station channel in the list of favorite television station channels in the database.

13. The method as claimed in claim 11, further comprising a step of placing a favorite television station channel newly selected for watching at a first place of the list when the user operation is the operation to look up favorite television station channels from the database.

14. The method as claimed in claim 11, further comprising a step of prompting key names one by one for users to choose a key from the keyboard for execution before the step of pressing a key from a keyboard of the remote control.

15. The method as claimed in claim 14, wherein voice prompting is used in the step of prompting key names one by one for users to choose a key.

16. The method as claimed in claim 11, wherein voice prompting is used in the step of prompting users of the remote control to operate the remote control.

17. The method as claimed in claim 11, further comprising a step of recording user's speaking voices as a part of additive information in the database.

18. The method as claimed in claim 17, further comprising a step of playing back the recorded voices for review after the step of recording user's speaking voices.

19. The method as claimed in claim 18, wherein the additive information in the database comprises a recorded television station name and a television channel number keyed in from the keyboard of the remote control, and both of the recorded television station name and the keyed-in television channel number are played back for review.

20. The method as claimed in claim 11, wherein a voice prompt of a television station name is played for review after the key is pressed and a television channel number is transmitted in response to pressing of the key.

21. A method to operate a remote control of a television, comprising:
establishing a database in the remote control to save a list of favorite television station channels;
pressing at least one key from a keyboard of the remote control to transmit a television channel number to the television to switch the television to a corresponding television station channel of the television channel number for watching;
comparing the television channel number with the list of favorite television station channels to acquire a television station name of the corresponding television station channel;
playing the television station name for users of the remote control to listen if the television channel number is found in the list of favorite television station channels; and
prompting the users to record users' voices of the television station name if the television channel number is not found in the list of favorite television station channels, and storing the television channel number and the recorded television station name at a first place of the list of favorite television station channels and moving other favorite television station channels listed in the list backwards in sequence.

22. The method as claimed in claim 21, wherein the at least one key from the keyboard is one of a “Channel Up/+” key, a “Channel Down/−” key and a key combination of digital keys to acquire the television channel number.

23. The method as claimed in claim 21, further comprising a step of playing back the recorded users' voices for review after the step of prompting the users to record users' voices.
